(19) United States
(12) Patent Application Publication
(10) Pub. No.: US 2014/0056573 A1
(43) Pub. Date: Feb. 27, 2014

(54) RECORDING PLAYBACK APPARATUS

(71) Applicant: Funai Electric Co., Ltd., Osaka (JP)

(72) Inventor: Hiroyuki Nakaya, Osaka (JP)

(73) Assignee: FUNAI ELECTRIC CO., LTD., Osaka (JP)

(21) Appl. No.: 13/913,615

(22) Filed: Jun. 10, 2013

(30) Foreign Application Priority Data
Aug. 27, 2012 (JP) 2012-186298

(51) Int. Cl. H04N 9/87

(52) U.S. Cl. CPC H04N 9/87
USPC 386/248

(57) ABSTRACT

A recording playback apparatus for a plurality of users that records and plays back files includes a control unit that controls a display unit to display a list encoded with an identification for each of the files of whether the file may be deleted, wherein the identification is selectable by each of the plurality of users, and an identification for each of the files of whether the file has been played back by each of the plurality of users.

### FIELD OF THE INVENTION

The present invention relates to recording playback apparatuses used by a plurality of users.

### BACKGROUND ART

In recent years, recording playback apparatuses called recorders, composed an optical disk (DVD or BD and the like) devices, hard-disk devices, or hybrid devices of these, have become popular. Such recording playback apparatuses are used alone by a single user, but generally, they are often commonly used among a plurality of users, such as family members.

In such a case, a recording region (a hard disk or the like) in a recording playback apparatus is shared, so each user is able freely to listen or to delete a recorded program. A variety of technologies have been proposed for a recording playback apparatus shared by a plurality of users.

For example, a recording playback apparatus is disclosed in patent document 1 that does not delete or overwrite content until the content of the reserved video is viewed by all who reserved the content, when content is shared with others with reservations.

A digital-television broadcast-recording device is disclosed in patent document 2 that is equipped with an input unit for inputting viewer information unique to each of a plurality of viewers; a viewer-information memory unit for storing viewer information of a predetermined viewer; and a viewer-information identifying unit that identifies a viewer by comparing viewer information inputted to the input unit, and viewer information stored in the viewer-information memory unit, to restrict recording, playback or deletion of a program according to identification results of the viewer-information identification unit.

A video-recording playback apparatus is disclosed in patent document 3 that records video data to an HDD or the like, by adding thereto a user identifier, when recording video, and that permits access to that recorded video data only when there is an identifier added to the targeted video data that matches the identifier of the user that specified that recording, in the playback and deletion operations.

Disclosed in patent document 4 is a video-recording apparatus equipped with a video-storage unit that stores video files; a memory unit that stores a table indicating settings to prohibit deletion and to permit deletion of each video file stored in the video-storage unit; and a rewriting unit that rewrites the table when a total volume of the video files prohibited for deletion stored in the video storage unit has reached a predetermined value.

### [Patent Documents]

[Patent Document 1] Japanese unexamined patent application publication 2005-92975
[Patent Document 2] Japanese unexamined patent application publication 2001-94928
[Patent Document 3] Japanese unexamined patent application publication 2007-266899
[Patent Document 4] Japanese unexamined patent application publication 2008-11407

However, the technologies disclosed in patent documents 1-4 are not constituted easily to judge a viewing status for each user, permission to delete, or no permission to delete each video program, and are not necessarily useful. Furthermore, there are recording playback apparatuses that enable a user to load and playback images and video the user has captured without accounting for how these files are handled.

### SUMMARY OF THE INVENTION

One or more embodiments of the present invention provide a useful recording playback apparatus that easily judges a viewing status for each user, permission to delete, or no permission to delete.

In one aspect, the present invention provides a recording playback apparatus for a plurality of users that records and plays back files, the recording playback apparatus comprising: a control unit that controls a display unit to display a list encoded with: an identification for each of the files of whether the file may be deleted, wherein the identification is selectable by each of the plurality of users, and an identification for each of the files of whether the file has been played back by each of the plurality of users.

In another aspect, the present invention provides a recording playback apparatus for a plurality of users, the recording playback apparatus comprising: a tuner that receives and demodulates a broadcast signal; a data processing unit that splits video and audio data and control data obtained from the tuner; a recording playback unit that records compressed video and audio data received from the data processing unit; and a control unit that controls a display unit to display a list encoded with: an identification for each of the video and audio data of whether the data may be deleted, wherein the identification is selectable by each of the plurality of users, and an identification for each of the video and audio data of whether the data has been played back by each of the plurality of users.

In another aspect, the present invention provides a method of operating a recording playback apparatus for a plurality of users that records and plays back files, the method comprising: identifying, for each of the files, whether the file may be deleted, wherein the identification is selectable by each of the plurality of users; and identifying, for each of the files, whether the file has been played back by each of the plurality of users.

According to one or more embodiments, the identification of whether the file has been played back can be selected for each of the files for each of the users.

According to one or more embodiments, before recording or after recording the files, the control unit prompts selection of an identifier that identifies the users that identified the file recording and sets a user field of the identifier selected to indicate that the file has not been played.

According to one or more embodiments, it may be useful for a user using the recording playback apparatus to be able easily to judge the viewing status for each user, OK to Delete, or Not OK to Delete for each file.

### BRIEF DESCRIPTION OF THE DRAWINGS

FIG. 1 is a block diagram of a constitution of a television system according to one or more embodiments of the present invention;

FIG. 2 is a flowchart showing operations related to file management on an HDD-integrated optical-disc apparatus according to one or more embodiments of the present invention; and

FIG. 3 is a drawing depicting an example of a video list in the HDD-integrated optical-disc apparatus according to one or more embodiments of the present invention.

### DETAILED DESCRIPTION OF THE INVENTION

Embodiments of the present invention will now be described using a hard-disk drive (HDD) integrated optical-disc apparatus as an example of the recording playback apparatus.

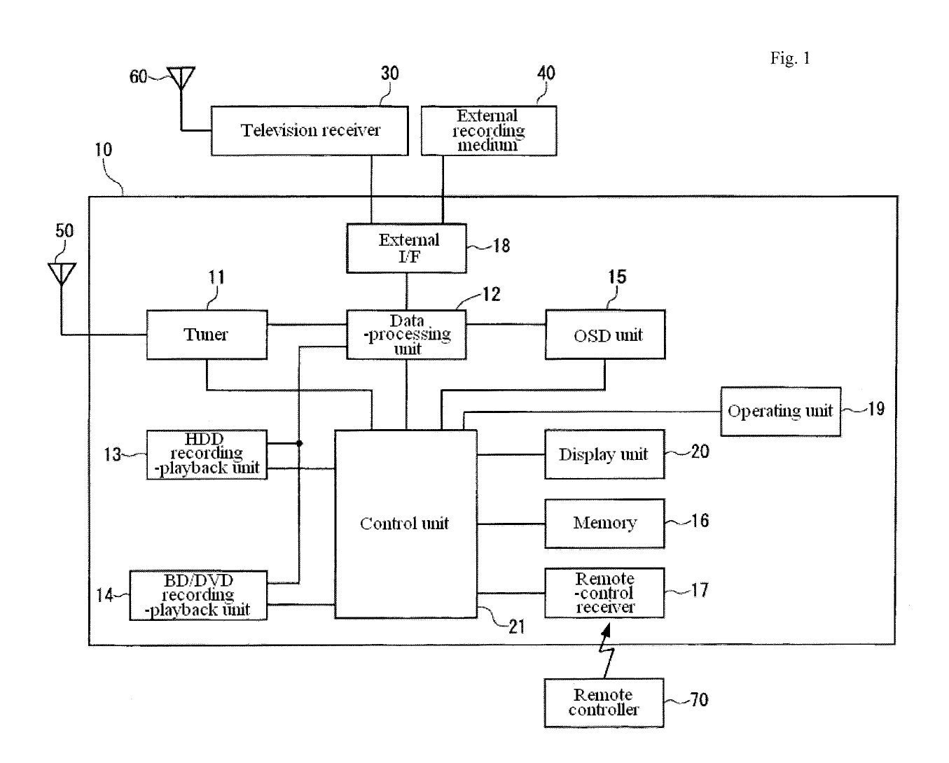

FIG. 1 is a block diagram of a constitution of a television system. This television system is composed of an HDD-integrated optical-disc apparatus according to one or more embodiments of the present invention, and its peripheral device. A television receiver 30 capable of receiving digital broadcasts, an external recording medium 40 such as an external HDD or memory card or the like, and an antenna 50 are connected to the HDD-integrated optical-disc apparatus 10. Also, an antenna 60 is connected also to the television receiver 30. Also, the HDD-integrated optical-disc apparatus 10 can be operated by a remote controller 70.

If an interface uni-directionally or bi-directionally transmits a video signal and audio signal, and a control signal bi-directionally, it can be used to connect the HDD-integrated optical-disc apparatus 10 and the television receiver 30, and the HDD-integrated optical-disc apparatus 10 and the external recording medium 40. For example, it is acceptable to use an HDMI terminal to connect the HDD-integrated optical-disc apparatus 10 and the television receiver 30. A USB terminal or card slot can be used to connect the HDD-integrated optical-disc apparatus 10 and the external recording medium 40.

Next, a configuration of the HDD-integrated optical-disc apparatus 10 will be described. The HDD-integrated optical-disc apparatus 10 is equipped with a tuner 11, a data-processing unit 12, and HDD recording playback unit 13, a BD (Blu-ray Disc)/DVD recording playback unit 14, and an OSD (On-screen Display) unit 15. The HDD-integrated optical-disc apparatus 10 is further equipped with a memory 16, a remote-control receiver 17, an external I/F 18, an operating unit 19, a display unit 20, and a control unit 21.

The tuner 11 demodulates and digitizes television broadcast signals received by the antenna 50. The data-processing unit 12 splits video and audio data and control data obtained from the tuner 11, television receiver 30, and the external recording medium 40. Conversely, this also joins output video and audio data, and control data. Also, the data-processing unit 12 demodulates video data, and compression-encodes video and audio data. Furthermore, the data-processing unit 12 elongates and decodes video and audio data obtained from the HDD recording playback unit 13, the BD/DVD recording playback unit 14, and external recording medium 40. Also, the data-processing unit 12 temporarily stores I/O data.

The HDD recording playback unit 13 records to HDD compressed video and audio data received from the data-processing unit 12, and loads recorded data to the HDD. The BD/DVD recording playback unit 14 records to an inserted BD or DVD compressed video and audio data received from the data-processing unit 12, and loads recorded data to the BD or the DVD.

The OSD unit 15 makes settings for various setting values including a video reservation and a video list while displaying a portion of the display unit (not shown in the drawing) of the television receiver 30. The memory 16 is composed of ROM and RAM; various programs and operational data are stored. The remote-control receiver 17 receives a signal from the remote controller 70.

Also, the television receiver 30 and the external recording medium 40 are connected to the external I/F 18. The operation unit 19 includes various operation keys a portion thereof being the same as operation keys for the remote controller 70. The display unit 20 is composed of a VFD (Vacuum Fluorescent Display), and simply displays an operating status.

The control unit 21 controls each unit of the HDD-integrated optical-disc apparatus 10. Specifically, the control unit 21 records various files to recording media (the HDD, BD, DVD or external recording medium 40) and controls playback of files. Recording a file includes copying or moving operations between recording media. Files are video recordings of programs in television broadcasts; they are handled as video, graphics and audio files, such as user captured movies, photos and music and other.

Also, the control unit 21 implements control to output to the display unit and the like of the television receiver 30 a list encoded with an identification of whether the file may be deleted (e.g., “OK to Delete/Not OK to Delete”) for a plurality of users of each file. Also, the control unit 21 implements control to enable selection of OK to Delete/Not OK to Delete for each file, for each user, in this list.

Also, it is acceptable to code the list with an identification of whether the file has been played (e.g., “played/not played”) for a plurality of users for each file. In such a case, the control unit 21 also implements control to enable selection of played back/not played back for each file, for each user, in this list.

Furthermore, the control unit 21 prompts selection of an identifier that identifies the user that specified the file recording, before recording or after recording the file to the recording medium, and implements control to set the user field of the identifier selected for that file in the list to Not-played.

The control unit 21 also implements a control automatically to delete a file that all registered users OK to Delete, or that all users have played back. It is also acceptable automatically to delete a file after a predetermined amount of time has passed (for example, after one week), after all registered users OK it to be deleted, or that all users have played back. These controls will now be described in detail below.

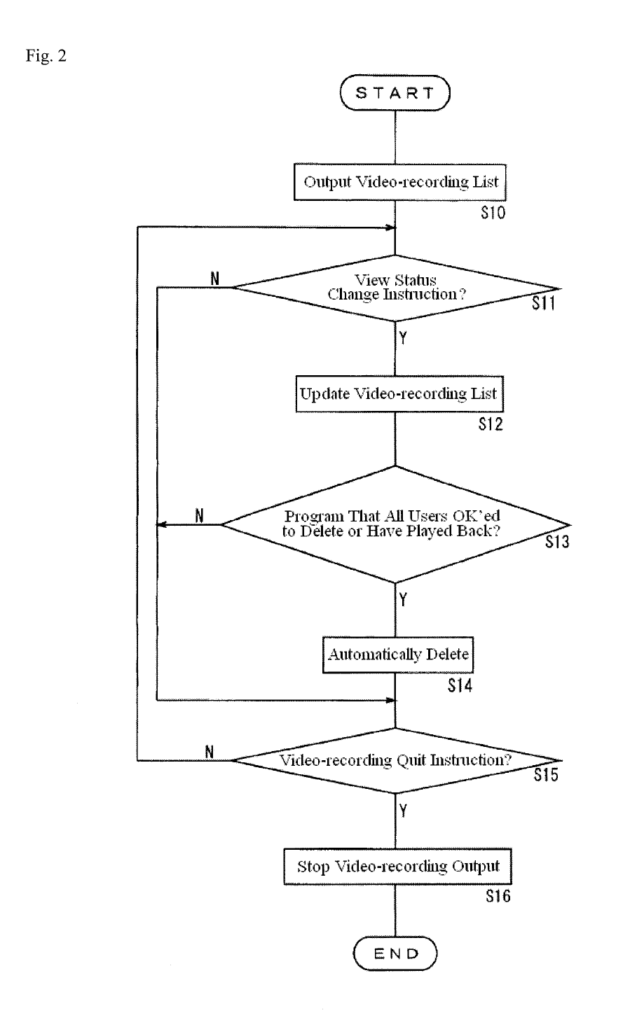

FIG. 2 is a flowchart showing operations related to file management on an HDD-integrated optical-disc apparatus 10. Here, a file for a program video-recorded onto the HDD of the HDD-integrated optical-disc apparatus 10 will be used in the description.

First, the remote controller 70 is operated (such as by pressing a video-recording list key) by the user, and when a video-recording list display is instructed, the control unit 21 controls to output that video-recording list to the television receiver 30, at step S10.

The video-recording list is a list of programs recorded on the HDD. It is acceptable always to store a latest video-recording list in the memory 16, or to create the list by referencing HDD-recorded content when the video-recording list key is pressed.

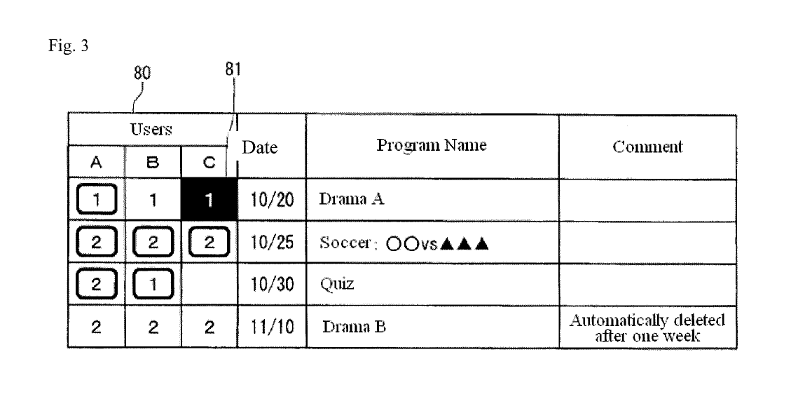

FIG. 3 depicts an example of the video-recording list. From the fields on the left, the recording list 80 includes registered user names, dates of video-recorded programs, program names, and comments. Three users, A, B, and C are registered, but that number is not a limitation. User registration is implemented on a pre-setup screen or the like.

A bottom field of the user name is a field showing each user's viewing status of each program (file). As a code for viewing status, “1” indicates not viewed (Not-played back); “2” indicates viewed (played back); the bold border indicates Not OK to Delete; no border indicates no desire to view (OK to Delete). For programs newly registered to the video-recording list 80, the viewing status for all users can be set automatically to “1” as a default value. Content automatically judged using the viewing status is shown in the Comments field. In FIG. 3, there is a comment indicating that the program in the bottommost field automatically will be deleted after one week.

Returning to the description of FIG. 2, the system advances from step S10 to step S11, and judges whether there is a change instruction for the viewing status. The remote controller 70 is operated by a user to implement this instruction. The user uses an up, down, left or right key to move a cursor 81 displayed with a color inverted on the video-recording list 80 to a desired field for the user's own user name, and selects a desired code by repeatedly pressing a confirmation key. The code cycles sequentially through “1,” “1 Bold Frame,” “2,” “2 Bold Frame,” and “No Code,” for example, each time the confirmation key is pressed.

When a change instruction is given for viewing status at step S11, the system advances to step S12, and the HDD-integrated optical-disc apparatus 10 switches the code for the field where the cursor 81 is positioned pursuant to the instruction. Then, when a predetermined amount of time (for example, two seconds) has passed with a code displayed, it is judged that that is the code desired by the user and updates the video-recording list 80 to that status.

The system advances from step S12 to step S13, and the control unit 21 searches the field of the viewing status of the updated video-recording list and judges whether it is a file that all registered users have OK'ed to be deleted or have played back, in other words whether it is a program for which all users A, B and C have set as “No code” or “2.”

At step S13, if there is a file that all registered users have OK'ed to be deleted or have played back, the system advances to step S14, and the control unit 21 controls automatically to delete that program after one week, and to display “automatically deleted after one week” in the video-recording list Comment field.

Conversely, at step S11, if there is no change instruction for the viewing status, or if there is no file that all users registered at step S13 have OK'ed to be deleted, or that has been played back, the system advances to step S15. At step S15, it is judged whether there is a quit instruction for the video-recording list. The remote controller 70 quit key, for example, is operated by the user to implement this instruction. Also, if the playback key is operated on the remote controller 70, it is considered to be the quit instruction for the video-recording list, to shift to the playback operation.

If there is a quit instruction for the video-recording list at step S15, the system advances to step S16, stops output of the video-recording list, and quits processing. Conversely, at step S15, if there is no quit instruction for the video-recording list, the system returns to step S11.

It possible for a user easily to judge user viewing status, OK to Delete and Not OK to Delete for each of the recorded video programs, using the video-recording list 80, so such a HDD-integrated optical-disc apparatus 10 is very useful. Furthermore, the HDD-integrated optical-disc apparatus 10 itself automatically judges and deletes a program to delete from the content of the video-recording list 80.

Also, it is acceptable for the user to omit step S13 and step S14, and manually delete a program by referencing the video-recording list viewing status. Also, instead of automatically deleting at step S14, it is acceptable to display a message recommending deletion, and to display selections enabling a selection of whether to OK delete.

Also, with the embodiments described above, when all users have OK'ed deletion or have played back a program, that program is deleted. However, it is also acceptable to delete a program only when all users have OK'ed deletion.

Also, it is acceptable to add a program that is reserved for video recording in the video-recording list. Also, a video-recorded program may be output separately as a video-recording reservation list. Still further, it is acceptable to set Not viewed or Not OK to Delete items for each user, for programs that are reserved for video recording.

Also, it is acceptable to display a popup screen prompting selection of the user name before playback or after playback, or when reserving a video recording, to select the user name. For example, when a user name is selected when reserving a video recording, it is possible automatically to set that program in the user name field to Not viewed “1” in the video-recording list after recording.

Also, it is possible to ascertain a status of a reservation for video recording with a reservation mark or the like, by looking at an EPG (electronic program guide). Therefore, if it is desired to view a program that someone else has reserved for video recording, it is acceptable to select that program, display the reservation list, and set that program field to Not viewed “1,” in the field for your own user name in the list, to indicate your intention also to view that program.

It is also acceptable for automatic deletion settings to be set to “Delete immediately” or “Delete after one week” or similar settings. It is acceptable for the user to set the number of days until deletion on a setup screen. Also, when automatically deleting after a predetermined number of days, it is acceptable to display a counter such as “XX days until deleted” in the video-recording list.

Also, when it is judged that there is inadequate capacity for recorded video, it is also acceptable to display a list of programs that may be deleted. It is acceptable for the list of programs that may be deleted to be a list of programs that all users have OK'ed to delete or that have been played back. With this, it is possible to increase the video recording capacity by the user selecting to delete some program.

Also, if the program is one that all users have set to Not delete, it is acceptable to display a message prompting to dub that program from the HDD to an optical disc or the like. After dubbing, the display can be switched from Not OK to Delete to dubbed, thereby allowing the video recording to be deleted from the HDD.

Also, even if set to Not OK to Delete, it is acceptable to display a message such as “Do you want to keep the data?” in the Comment field of the video-recording list if the predetermined amount of time has passed, or to flash the Not OK to Delete mark, to confirm whether the user really does not want to delete the data.

Also, when the apparatus recognizes by which user it is being used, it is acceptable automatically to apply the Not OK to Delete mark when the same user plays the same program a number of times (for example, three times). In such a case, the mark color may automatically change in the display so that it can be understood that the Not OK to Delete mark has been applied.

In the embodiments described above, a broadcast program is used as an example in the description. However, it is acceptable to use another file, such as one for a photo, music or video data loaded from the external recording medium 40 and the like, and not only a program. In such a case, viewed corresponds to played back, and not viewed corresponds to not played back.

It is also acceptable to set items for each user coded in the list of files at least to Not OK to Delete, and OK to Delete. In other words, viewed (played back) and not viewed (not played back) can be eliminated. In such a case, for example, the codes for viewing status in the video-recording list can be switched to Not OK to Delete “X” and OK to Delete “0” and for the default value for each user to be Not OK to Delete “X.”

The recording playback apparatus of the present invention can be used in a recording playback apparatus such as an optical-disc apparatus or a hard disk apparatus and the like, or it can be used in a hybrid device, for example an HDD-integrated optical-disc apparatus, that incorporates a plurality of recording playback units in one frame. Although the disclosure has been described with respect to only a limited number of embodiments, those skilled in the art, having benefit of this disclosure, will appreciate that other embodiments can be devised which do not depart from the scope of the present disclosure. Accordingly, the scope of the present disclosure should be limited only by the attached claims.

### EXPLANATION OF LETTERS OR NUMERALS

10 HDD-integrated optical-disc apparatus (recording playback apparatus)
11 Tuner
12 Data-processing unit
13 HDD recording-playback unit
14 BD/DVD recording-playback unit
15 OSD unit
16 Memory
17 Remote-control receiver
18 External I/F
19 Operating unit
20 Display unit
21 Control unit
30 Television receiver
40 External recording medium
50, 60 Antennae
70 Remote controller

What is claimed is:

1. A recording playback apparatus for a plurality of users that records and plays back files, the recording playback apparatus comprising:
a control unit that controls a display unit to display a list encoded with:
an identification for each of the files of whether the file may be deleted, wherein the identification is selectable by each of the plurality of users, and
an identification for each of the files of whether the file has been played back by each of the plurality of users.

2. The recording playback apparatus according to claim 1, wherein the identification of whether the file has been played back can be selected for each of the files for each of the users.

3. The recording playback apparatus according to claim 1, wherein, before recording or after recording the files, the control unit prompts selection of an identifier that identifies the users that identified the file recording and sets a user field of the identifier selected to indicate that the file has not been played.

4. The recording playback apparatus according to claim 1, wherein the control unit automatically deletes the file if all the users identified that the file may be deleted or if all the users have played back the file.

5. The recording playback apparatus according to claim 4, wherein the control unit waits for a predetermined amount of time before automatically deleting the file.

6. The recording playback apparatus according to claim 2, wherein, before recording or after recording the files, the control unit prompts selection of an identifier that identifies the users that identified the file recording and sets a user field of the identifier selected to indicate that the file has not been played.

7. The recording playback apparatus according to claim 2, wherein the control unit automatically deletes the file if all the users identified that the file may be deleted or if all the users have played back the file.

8. The recording playback apparatus according to claim 3, wherein the control unit automatically deletes the file if all the users identified that the file may be deleted or if all the users have played back the file.

9. A recording playback apparatus for a plurality of users, the recording playback apparatus comprising:
a tuner that receives and demodulates a broadcast signal;
a data processing unit that splits video and audio data and control data obtained from the tuner;
a recording playback unit that records compressed video and audio data received from the data processing unit; and
a control unit that controls a display unit to display a list encoded with:
an identification for each of the video and audio data of whether the data may be deleted, wherein the identification is selectable by each of the plurality of users, and
an identification for each of the video and audio data of whether the data has been played back by each of the plurality of users.

10. The recording playback apparatus according to claim 9, wherein the identification of whether the video and audio data has been played back can be selected for each of the video and audio data for each of the users.

11. The recording playback apparatus according to claim 9, wherein, before recording or after recording the video and audio data, the control unit prompts selection of an identifier that identifies the users that identified the video and audio data recording and sets a user field of the identifier selected to indicate that the video and audio data has not been played.

12. The recording playback apparatus according to claim 9, wherein the control unit automatically deletes the video and audio data if all the users identified that the video and audio data may be deleted or if all the users have played back the video and audio data.

13. The recording playback apparatus according to claim 12, wherein the control unit waits for a predetermined amount of time before automatically deleting the video and audio data.

14. The recording playback apparatus according to claim 10, wherein, before recording or after recording the video and audio data, the control unit prompts selection of an identifier that identifies the users that identified the video and audio data recording and sets a user field of the identifier selected to indicate that the video and audio data has not been played.

15. The recording playback apparatus according to claim 10, wherein the control unit automatically deletes the video and audio data if all the users identified that the video and audio data may be deleted or if all the users have played back the video and audio data.

16. The recording playback apparatus according to claim 11, wherein the control unit automatically deletes the video and audio data if all the users identified that the video and audio data may be deleted or if all the users have played back the video and audio data.

17. A method of operating a recording playback apparatus for a plurality of users that records and plays back files, the method comprising:
controlling a display unit to display a list encoded with:
an identification for each of the files of whether the file may be deleted, wherein the identification is selectable by each of the plurality of users, and
an identification for each of the files of whether the file has been played back by each of the plurality of users.
